(19) United States
(12) Patent Application Publication
(10) Pub. No.: US 2013/0221881 A1
(43) Pub. Date: Aug. 29, 2013

(54) DRIVING APPARATUS AND DRIVING METHOD

(71) Applicant: Sony Corporation, (US)

(72) Inventor: Kousuke Tsuchihashi, Kanagawa (JP)

(73) Assignee: Sony Corporation, Tokyo (JP)

(21) Appl. No.: 13/768,868

(22) Filed: Feb. 15, 2013

(30) Foreign Application Priority Data
Feb. 29, 2012 (JP) 2012-043440

(51) Int. Cl. H02P 6/14

(52) U.S. Cl. CPC H02P 6/14
USPC 318/400.09

(57) ABSTRACT

A driving apparatus is configured to switch states in one modulation period so as to include a conductive state in a first drive direction, a conductive state in a second drive direction having a polarity different from the conductive state in the first drive direction, and a ground state at least when a motor output is in a low output region including a case where a duty ratio of a PWM control is at zero, in which the duty ratio is changed by changing periods of the respective states.

### BACKGROUND

The present disclosure relates to a driving apparatus configured to drive a motor and a driving method.

As a driving system for a motor, a PWM (Pulse Width Modulation) control system is proposed. This PWM control system includes an alternating drive PWM control system. On the other hand, the PWM control system also includes an intermittent drive PWM control system other than the alternating drive PWM control system.

The intermittent drive PWM control system has a problem that a linearity characteristic of a motor output is decreased in a low output region. As a system for improving this concern, a system is suggested in which the alternating drive PWM control system is executed in a region where the motor output has a low output, and the intermittent drive PWM control system is executed in a region where the motor output has a high output (for example, Japanese Unexamined Patent Application Publication No. 2006-042442).

### SUMMARY

According to the technology disclosed in Japanese Unexamined Patent Application Publication No. 2006-042442, the intermittent drive PWM control system and the alternating drive PWM control system are switched to be executed. One cycle as an entirety of the control is composed of one cycle in the intermittent drive PWM control system and one cycle in the alternating drive PWM control system. For this reason, the one cycle for applying the pulse voltage is lengthened as compared with a cycle where the intermittent drive PWM control system or the alternating drive PWM control system alone is carried out. Because of the lengthening of the cycle, a problem occurs that a frequency of sound generated from the motor is changed into a frequency in an audio range, and the motor sound may be heard as noise.

Therefore, according to an embodiment of the present disclosure, it is desirable to provide a driving apparatus that can avoid the decrease in the linearity characteristic of the motor output while the generation of the noise from the motor is avoided and a driving method.

A driving apparatus according to an embodiment of the present disclosure is, for example, configured to switch states in one modulation period so as to include a conductive state in a first drive direction, a conductive state in a second drive direction having a polarity different from the conductive state in the first drive direction, and a ground state at least when a motor output is in a low output region including a case where a duty ratio of a PWM control is at zero, in which the duty ratio is changed by changing periods of the respective states.

A driving method according to another embodiment of the present disclosure includes, for example, at least when a motor output is in a low output region including a case where a duty ratio of a PWM control is at zero, switching states in one modulation period so as to include a conductive state in a first drive direction, a conductive state in a second drive direction having a polarity different from the conductive state in the first drive direction, and a ground state, and changing periods of the respective states to change the duty ratio.

According to at least one of the embodiments of the present disclosure, while the generation of the noise from the motor is avoided, the decrease in the linearity characteristic of the motor output can be avoided.

### BRIEF DESCRIPTION OF THE DRAWINGS

FIG. 1 illustrates a configuration example of a driver circuit in an alternating drive PWM control system;

FIGS. 2A and 2B are explanatory diagrams for describing a control of the alternating drive PWM control system;

FIGS. 3A, 3B, and 3C are explanatory diagrams for describing a control of an intermittent drive PWM control system;

FIG. 4 is an explanatory diagram for describing a difference between a power consumption of the alternating drive PWM control system and a power consumption of the intermittent drive PWM control system;

FIG. 5 is an explanatory diagram for describing an example of a region where a linearity of a motor output is decreased;

FIGS. 6A, 6B, and 6C are explanatory diagrams for describing three states of the motor in one cycle;

FIGS. 7A and 7B illustrate examples of a pulse width of a pulse voltage;

FIG. 8 is an explanatory diagram for describing an occurrence of a delay when a voltage rises;

FIG. 9 illustrates a configuration example of a driving apparatus;

FIG. 10 illustrates an example of a control logic value in the driving apparatus;

FIGS. 11A and 11B illustrate a waveform of a pulse voltage applied in the intermittent drive PWM control system in contrast with a waveform of a pulse voltage applied in a present control system;

FIG. 12 illustrates examples of a pulse width of the pulse voltage applied in the present control system;

FIGS. 13A and 13B illustrate a change in a potential difference between both ends of the motor in the intermittent drive PWM control system in contrast with a change in a potential difference between both the ends of the motor in the present control system;

FIGS. 14A and 14B illustrate examples of a pulse width in a region where the motor output has a high output when a mode is a forward rotation; and

FIGS. 15A and 15B illustrate examples of a pulse width in a region where the motor output has a high output when a mode is a reverse rotation.

### DETAILED DESCRIPTION OF EMBODIMENTS

Hereinafter, an embodiment of the present disclose will be described with reference to the drawings. It should be noted that the description will be made in the following order.
1. Embodiment
2. Modified Examples

It should be noted that an embodiment and modified examples which will be described below are exemplary specific examples of the present disclosure, and the contents of the present disclosure are not limited to these embodiment and modified examples.

### 1. Embodiment

### Regarding Related Art Technologies

First, an alternating drive PWM control system and an intermittent drive PWM control system which are technologies related to the present disclose will be described.

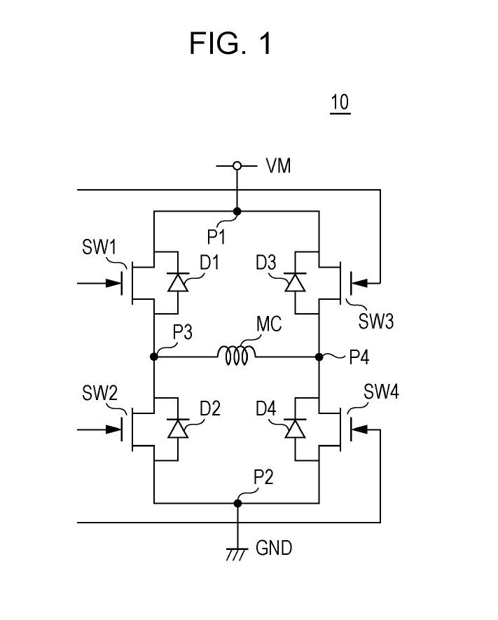

FIG. 1 illustrates a configuration example of a driver circuit 10 that is provided in a last stage of a motor driving apparatus configured to perform a motor driving control based on the alternating drive PWM control system. The driver circuit 10 includes a switching element SW1, a switching element SW2, a switching element SW3, and the switching element SW4. The switching element is composed, for example, of an FET (Field Effect Transistor).

The switching elements SW1 to SW4 are subjected to bridge connections, and also diodes D1 to D4 are respectively connected to the switching elements SW1 to SW4 in parallel. A connection middle point P1 for the first and third switching elements SW1 and SW3 is connected to a power supply line VM. A connection middle point P2 for the second and fourth switching elements SW2 and SW4 is connected to a ground GND.

In the driver circuit 10, a coil MC in a motor (which will appropriately be referred as motor coil) corresponding to a driving target is connected between a connection middle point P3 for the first and second switching elements SW1 and SW2 and a connection middle point P4 for the third and fourth switching elements SW3 and SW4.

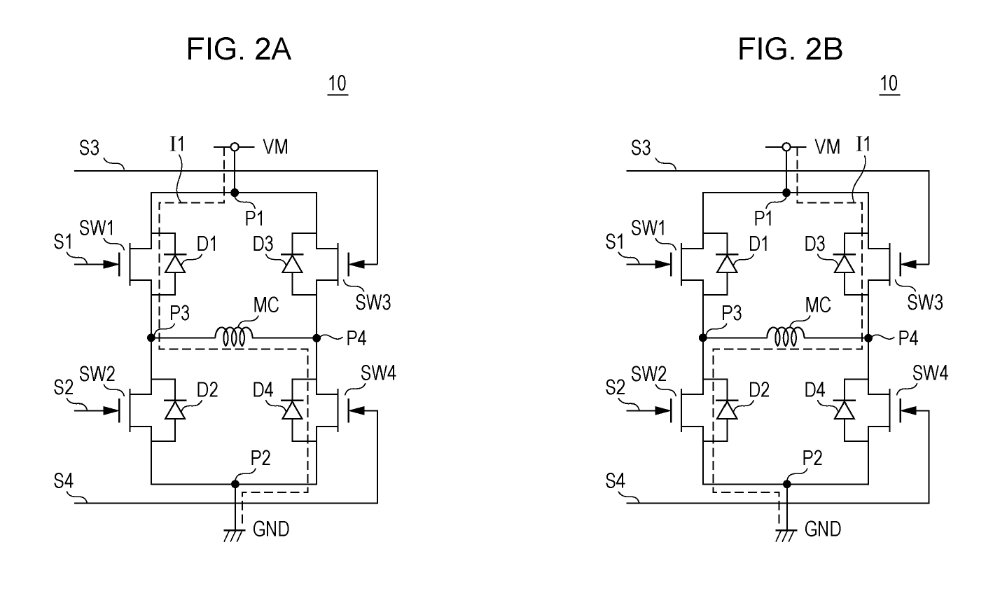

In the driver circuit 10, as illustrated in FIG. 2A, the switching element SW1 is applied with a drive signal S1, and the switching element SW4 is applied with a drive signal S4, so that the switching element SW1 and the switching element SW4 are turned on. The switching element SW2 and the switching element SW4 are turned off. Through this control, for example, the motor coil MC can be applied with a drive current I1 in a forward rotation direction.

In contrast to this, as illustrated in FIG. 2B, the switching element SW2 is applied with a drive signal S2, and the switching element SW3 is applied with a drive signal S3, so that the switching element SW2 and the switching element SW3 are turned on. The switching element SW1 and the switching element SW4 are turned off. Through this control, for example, the motor coil MC can be applied with the drive current I1 in an opposite direction (reverse rotation direction) to the forward rotation direction.

In the alternating drive PWM control system, when an inductance of the motor coil MC is sufficiently high, an effective current hardly flows in theory. However, in an actual motor, the inductance of the motor coil MC is finite, and a problem occurs that a wasteful current flows even in a neutral state to consume the power.

On the other hand, as the PWM control system, the intermittent drive PWM control system is proposed in addition to the alternating drive PWM control system. Also in the case of the motor driving apparatus configured to perform the motor driving control based on the intermittent drive PWM control system, a driver circuit 20 having a configuration similar to the driver circuit 10 is provided in the last stage.

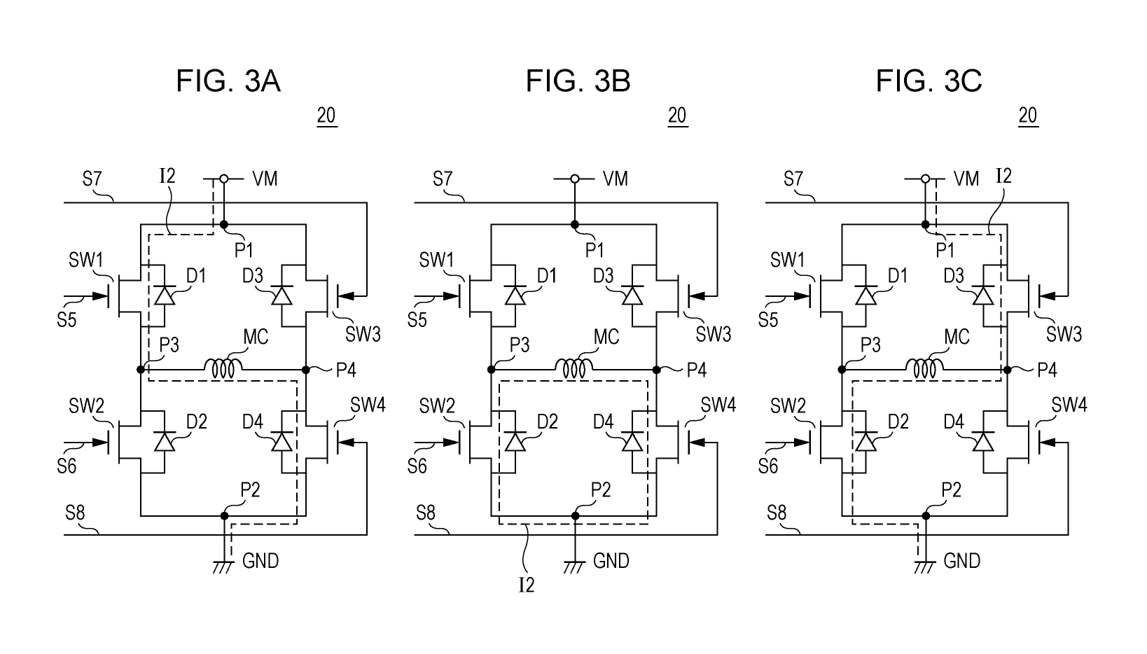

In the driver circuit 20, as illustrated in FIG. 3A, the switching element SW1 is applied with a drive signal S5, and the switching element SW4 is applied with a drive signal S8, so that the switching elements SW1 and SW4 are turned on. The switching elements SW2 and SW3 are turned off. Through this control, the motor coil MC can be applied with a drive current I2 in the forward rotation direction.

In contrast to this, as illustrated in FIG. 3B, the switching element SW2 is applied with a drive signal S6, and the switching element SW4 is applied with the drive signal S8, so that the switching elements SW2 and SW4 are turned on. The switching elements SW1 and SW3 are turned off. Through this control, it is possible to establish a state in which the motor coil MC is not applied with the drive current I2.

Furthermore, as illustrated in FIG. 3C, the switching element SW2 is applied with the drive signal S6, and the switching element SW3 is applied with a drive signal S7, so that the switching elements SW2 and SW3 are turned on. The switching elements SW1 and SW4 are turned off. Through this control, the motor coil MC can be applied with the drive current I2 in the reverse rotation direction.

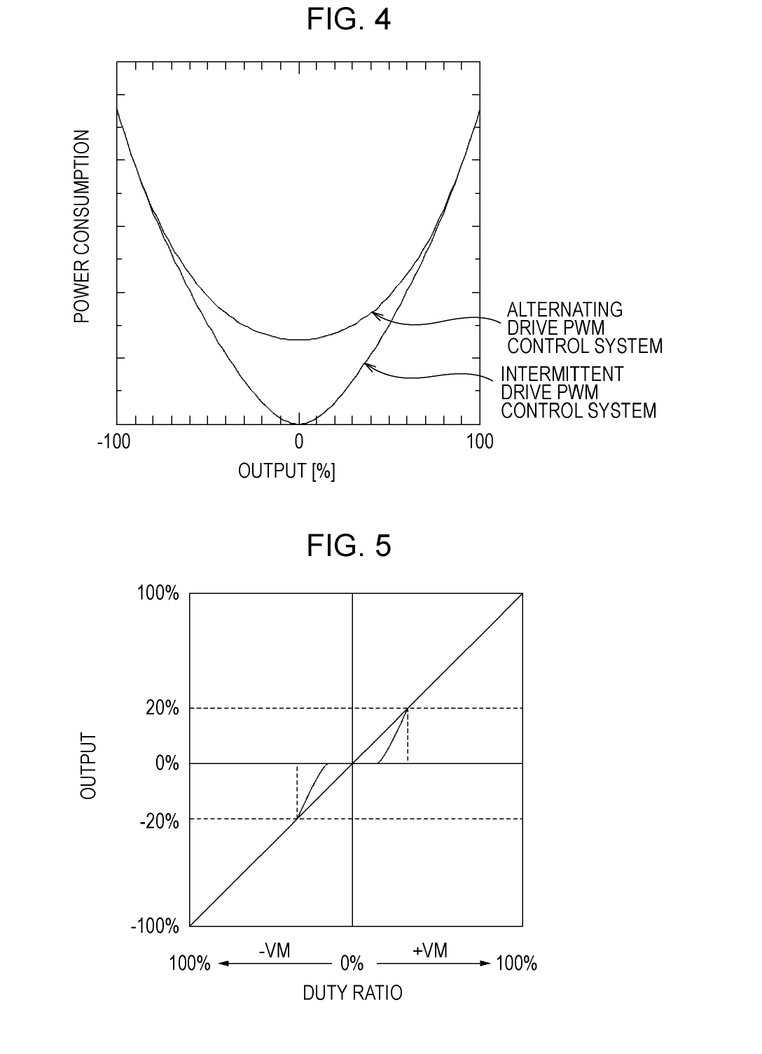

According to the above-mentioned intermittent drive PWM control system, since the motor coil MC is applied with a unipolar pulse voltage PV, the wasteful current hardly flows into the motor coil MC. For this reason, as schematically illustrated in FIG. 4, as compared with the alternating drive PWM control system where the motor coil MC is applied with the bipolar pulse voltage PV, the intermittent drive PWM control system is superior in terms of power consumption.

Incidentally, in the alternating drive PWM control system and the intermittent drive PWM control system, in accordance with an output delay time of the driver circuit, minimum pulse widths of the drive signals S1 to S4 and S5 to S8 are decided. The output delay time of the driver circuit is decided in accordance with at least one of a response at a time of the on/off switching for the switching elements SW1 to SW4 and a dead time provided for the time of the on/off switching to avoid a power supply short circuit.

When the pulse widths of the drive signals S1 to S4 and S5 to S8 are close to a response limit, a linearity characteristic of an effective voltage of the pulse voltage for a duty ratio setting, that is, the linearity characteristic of the motor output is decreased.

In actuality, in the alternating drive PWM control system, the pulse widths of the drive signals S1 to S4 in the vicinity of the respective positive and negative motor outputs 100% are set to be small. For this reason, in a high output region in the vicinity of the respective positive and negative motor outputs 100%, the decrease in the linearity characteristic of the motor output occurs.

On the other hand, in the intermittent drive PWM control system, the pulse widths of the drive signals S5 to S8 in the vicinity of the motor output 0% and in the vicinity of the respective positive and negative motor outputs 100% are set to be small. For example, in a case where the motor is put into a forward rotation state, if the pulse width is sufficiently secured, an output voltage value of the motor rises. On the other hand, in a case where the pulse width is small, the output voltage value does not fully rise. For this reason, in a low output region in the vicinity of the motor output 0% and the high output region in the vicinity of the respective positive and negative motor outputs 100%, the decrease in the linearity characteristic of the motor output occurs.

Since a duty ratio region where the linearity characteristic of the motor output is decreased is decided from a ratio of PWM frequencies corresponding to PWM frequencies of the switching elements SW1 to SW4 to the pulse widths of the response limits for the switching elements SW1 to SW4 of the driver circuits 10 and 20, in the case of the same PWM frequency, the intermittent drive PWM control system has an advantage that the linearity characteristic can be guaranteed up to a higher output region.

However, as schematically illustrated in FIG. 5, the intermittent drive PWM control system has a problem that the linearity characteristic of the motor output is decreased in the low output region (for example, in a range between −20% to 20%). According to the present disclosure, a control of avoiding the decrease in the linearity characteristic of the motor is carried out. When this control is carried out, a generation of noise from the motor is to be avoided.

### Outline of the Present Disclosure

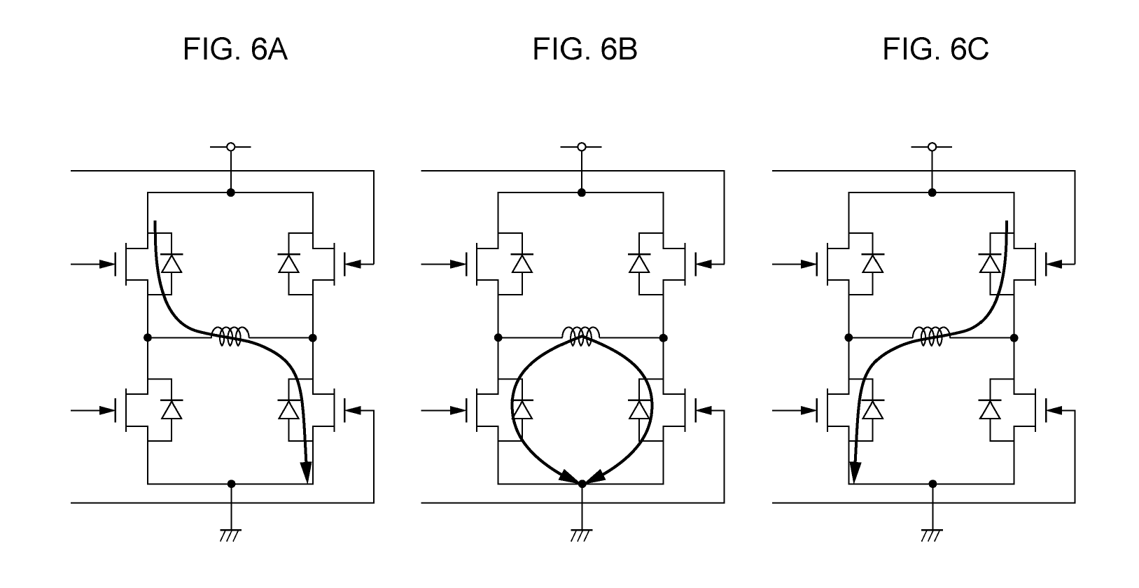

To facilitate the understanding of the contents of the present disclosure, an outline of the present disclosure will be described. The driving apparatus according to the present disclosure is configured to drive, for example, a DC (Direct Current) motor. As illustrated in FIGS. 6A, 6B, and 6C, the driving apparatus according to driving apparatus performs a control of executing three states including a forward rotation corresponding to an example of a conductive state in a first drive direction (FIG. 6A), a brake corresponding to an example of a ground state (FIG. 6B), and a reverse rotation corresponding to an example of a conductive state in a second drive direction (FIG. 6C) in one modulation period (in one carrier). Arrows in FIGS. 6A, 6B, and 6C schematically illustrate the conductive states.

At least when the motor output including the case of the PWM control duty ratio at 0% is in the low output region, the respective states are switched so as to include the three states in the one modulation period. The duty ratio is changed by changing the periods of the respective states. The low output region of the motor refers to a region where the linearity characteristic of the motor is decreased, and a region where, for example, the motor output is in a range between −20% or higher and +20% or lower. The high output region of the motor refers to a region where, for example, the motor output is in a range between −100% or higher and lower than −20% and the motor output is in a range between higher than +20% and +100% or lower. Other ranges may also be set as the ranges of the low output region and the high output region.

It should be noted that the one modulation period is synonymous with one cycle, and in the following description, the one modulation period may be referred to as one cycle in some cases. Furthermore, the control executed according to the present disclosure may be referred to as present control system in some cases.

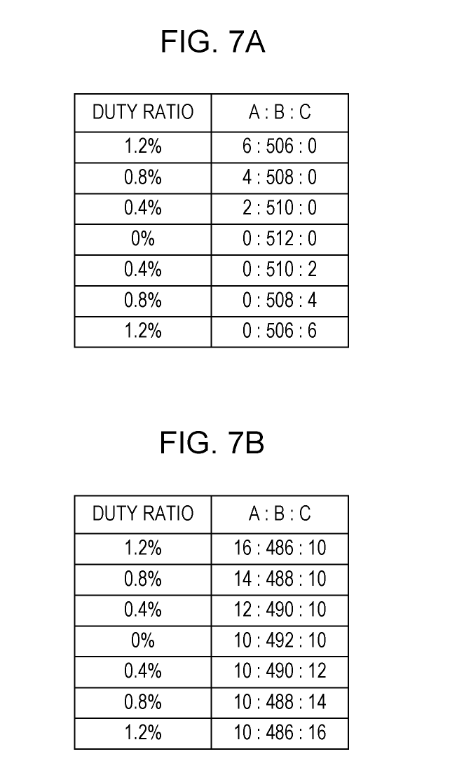

FIGS. 7A and 7B illustrate examples of transitions of the respective states of the motor in the one cycle. In FIGS. 7A and 7B, for example, the one cycle is defined while 512 based on the hexadecimal number is set as a unit. The one cycle may also be defined while another numeric value such as 1024 is set as a unit. Among A, B, and C illustrated in FIGS. 7A and 7B, A denotes a pulse width of the pulse voltage applied for executing the forward rotation state of the motor, and when this pulse voltage continues to be applied to the driver circuit, the motor rotates the forward rotation direction. B denotes a pulse width of the pulse voltage for executing the brake state of the motor. C denotes a pulse width of the pulse voltage for executing the reverse rotation state of the motor, and when this pulse voltage continues to be applied to the driver circuit, and the motor rotates the reverse rotation direction.

In a case where the motor is the forward rotation, the duty ratio is calculated, for example, by (A−C)/512 (it is noted that / represents a division). In a case where the motor is the reverse rotation, the duty ratio is calculated, for example, by (C−A)/512.

FIG. 7A illustrates examples of the pulse width of the pulse voltage applied in the one cycle of the intermittent drive PWM control system. In the case of the duty ratio at 0%, the pulse voltage for executing the forward rotation or the reverse rotation may not be applied. Therefore, the pulse width (A) for executing the forward rotation state is 0, and the pulse width (C) for executing the reverse rotation state is also 0. The pulse width (B) is set as 512.

For the execution when the duty ratio in a case where the motor is the forward rotation is in the vicinity of 0% (for example, 0.4%, 0.8%, and 1.2%), the pulse voltage is applied. The pulse width (A) of the pulse voltage applied at this time is changed in accordance with the duty ratio but is set, for example, as 2, 4, 6, . . . . The pulse width (C) is set as 0.

For the execution when the duty ratio in a case where the motor is the reverse rotation is in the vicinity of 0% (for example, 0.4%, 0.8%, and 1.2%), the pulse voltage is applied. The pulse width (C) of the pulse voltage applied at this time is changed in accordance with the duty ratio but is set, for example, as 2, 4, 6, . . . . The pulse width (A) is set as 0.

As described above, in the vicinity of the duty ratio at 0%, the pulse width (A) or the pulse width (C) is set to be small. For this reason, even when a predetermined switching element is applied with the pulse voltage, the switching element does not fully rise, and the effective voltage applied to the motor does not sufficiently fully rise. That is, the linearity of the motor output is decreased.

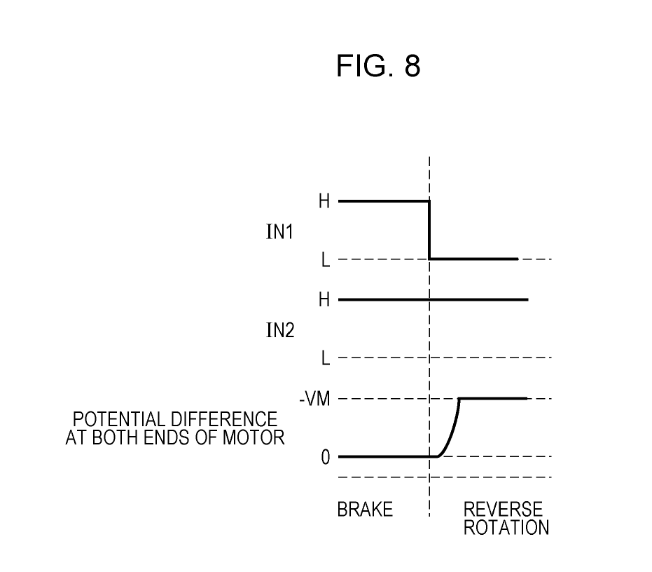

As schematically illustrated in FIG. 8, in accordance with a level of an (input) signal IN1 and a level of an (input) signal IN2, the state of the motor is designed to be switched. For example, in a case where the signal level of the signal IN1 is changed from Hi (H) to Low (L), the state of the motor is switched from the brake state to the reverse rotation state. At the time of this switching, for example, when the switching element SW1 and the switching element SW2 of the driver circuit are turned on at the same time, a power supply VW and the ground GND are short-circuited. To avoid this situation, a certain time width (dead time) is set, and the short circuit is to be avoided.

Furthermore, since a time for the respective switching elements to execute a switching function is finite, a delay is generated while the transition of the signal IN1 and the signal IN2 is set as a reference. In the present control system, a predetermined time width is decided while taking this delay and the like into account. With the application of the pulse voltage having a pulse width that is larger than or equal to the predetermined time width, the switching element is turned on, and it can be guaranteed that the output voltage rises.

In the present control system, the pulse voltages having mutually different polarities are applied in the same cycle. Subsequently, the pulse widths for applying the respective pulse voltages are set to be larger than or equal to the predetermined time width.

FIG. 7B illustrates examples of the pulse width of the pulse voltage applied in the one cycle of the present control system. In the example illustrated in FIG. 7B, the predetermined time width is set as 10. At the duty ratio at 0%, the pulse width (A) is set as 10, and the pulse width (C) is set as 10. The pulse width (B) is set as 492 calculated by subtracting the pulse width (A) and the pulse width (B) from 512 corresponding to the unit of the one cycle. Since a difference between the pulse width (A) and the pulse width (C) is 0, the duty ratio is 0%.

For example, in a case where the motor has the forward rotation and realizes the duty ratio at 0.4%, the pulse width (A) is set as a pulse width at I2 which is larger than or equal to the predetermined time width at 10. The pulse width (C) of the pulse voltage is set as the time width at 10 that is the same as the predetermined time width. The pulse width (B) is set as 490 from the calculation of 512−10−12. When the duty ratio is calculated, on the basis of (12−10)/512, the duty ratio is 0.4%.

In the present control system, since both the pulse width (A) and the pulse width (C) are larger than or equal to the predetermined time width, the switching element of the driver circuit is reliably turned on, and the voltage rises. For this reason, the desired duty ratio is realized, and it is possible to avoid the decrease in the linearity of the motor output.

### Configuration of Driving Apparatus

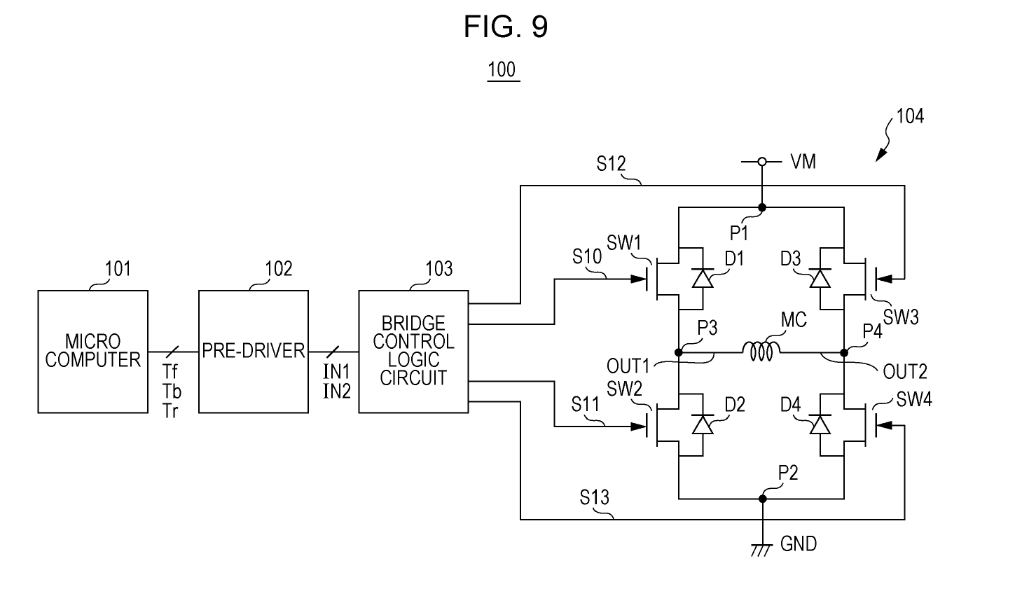

FIG. 9 illustrates a configuration example of a driving apparatus configured to drive a motor. A driving apparatus 100 has a configuration including a micro computer 101, a pre-driver 102, a bridge control logic circuit 103, and a driver circuit 104.

The micro computer 101 functions as a superior controller. The micro computer 101 may be composed, for example, of a DSP (Digital Signal Processor). The micro computer 101 reads out a pulse width Tf, a pulse width Tb, and a pulse width Tr in accordance with the duty ratio. The pulse width Tf, the pulse width Tb, and the pulse width Tr corresponding to the duty ratio are previously decided. The previously decided pulse widths are stored, for example, in a memory in a table format. The pulse width Tf, the pulse width Tb, and the pulse width Tr may also be supplied from an external apparatus.

The micro computer 101 reads out the pulse width Tf, the pulse width Tb, and the pulse width Tr corresponding to the desired duty ratio. The pulse width Tf is a pulse width of the pulse voltage for executing the conductive state in the first drive direction. The pulse width Tr is a pulse width of the pulse voltage for executing the conductive state in the second drive direction. The pulse width Tb is a pulse width of the pulse voltage for executing the ground state. The pulse width Tf and the pulse width Tr are set to be larger than or equal to the predetermined time width. The pulse width Tb is set as a time width calculated by subtracting the pulse width Tf and the pulse width Tr from the unit of the one cycle.

The pre-driver 102 is configured to convert a signal generated at an operation frequency of the micro computer 101 into a signal at a frequency for executing the PWM control. For example, the operation frequency of the micro computer 101 is set as 2 kHz (kilohertz). The frequency for executing the PWM control is set as 26 kHz. The signal supplied from the micro computer 101 is converted by the pre-driver 102 into a signal that can be used at 26 kHz.

The pre-driver 102 is connected to the bridge control logic circuit 103, for example, two lines. Of course, the pre-driver 102 may be connected to the bridge control logic circuit 103 by three lines while corresponding to the pulse width Tf, the pulse width Tb, and the pulse width Tr. Among the two lines, one of the lines is used to transmit the (input) signal IN1. The other line is used to transmit the (input) signal IN2. It should be noted that the signal IN1 and the signal IN2 are transmitted in accordance with a frequency for executing the PWM control (for example, 26 kHz).

The bridge control logic circuit 103 controls the driver circuit 104 in accordance with the level of the signal supplied from the pre-driver 102. The bridge control logic circuit 103 generates drive signals S10 to S13 for respectively driving the switching elements SW1, SW2, SW3, and SW4.

When the forward rotation state of the motor is executed, the bridge control logic circuit 103 supplies the switching element SW1 with the drive signal S10 to turn on the switching element SW1. Furthermore, the bridge control logic circuit 103 supplies the switching element SW4 with the drive signal S13 to turn on the switching element SW4. The switching element SW2 and the switching element SW3 are turned off.

When the brake state of the motor is executed, the bridge control logic circuit 103 supplies the switching element SW2 with the drive signal S11 to turn on the switching element SW2. Furthermore, the bridge control logic circuit 103 supplies the switching element SW4 with the drive signal S13 to turn on the switching element SW4. The switching element SW1 and the switching element SW3 are turned off.

When the reverse rotation state of the motor is executed, the bridge control logic circuit 103 supplies the switching element SW2 with the drive signal S11 to turn on the switching element SW2. Furthermore, the bridge control logic circuit 103 supplies the switching element SW3 with the drive signal S12 to turn on the switching element SW3. The switching element SW1 and the switching element SW4 are turned off.

The driver circuit 104 has a configuration similar to the driver circuit 10 or the driver circuit 20 described above. That is, the first switching element SW1 is directly connected to the second switching element SW2. The third switching element SW3 is directly connected to the fourth switching element SW4.

The motor coil MC is connected between the connection middle point P3 for the switching element SW1 and the switching element SW2 and the connection middle point P4 for the switching element SW3 and the switching element SW4.

### Example of Control Logic Value

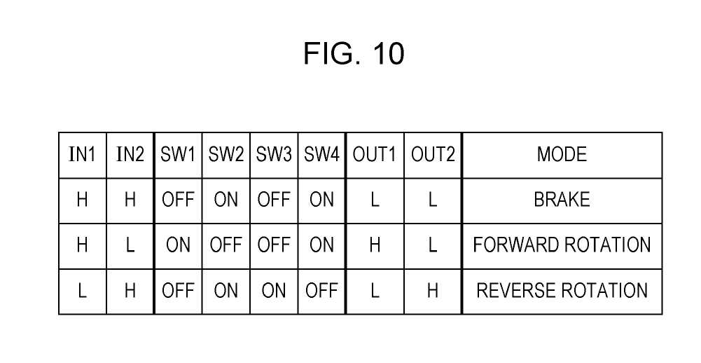

FIG. 10 illustrates an example of a control logic value for executing each of the three states (modes) of the motor. When the brake state of the motor is executed, the signal level of the signal IN1 is set as H, and the level of the signal IN2 is set as H. A time corresponding to the time width for setting the motor in the brake state, the signal IN1 at the H level, and the signal IN2 at the H level are supplied from the pre-driver 102 to the bridge control logic circuit 103.

The bridge control logic circuit 103 turns on the switching element SW2 and the switching element SW4 in accordance with the supplied signal and turns off the switching element SW1 and the switching element SW3. The voltage levels at both ends (OUT1 and OUT 2) of the motor coil MC are both set as L.

When the control for setting the motor in the forward rotation state is executed, the signal level of the signal IN1 is set as H, and the signal level of the signal IN2 is set as L. A time corresponding to the time width for setting the motor in the forward rotation state, the signal IN1 at the H level, and the signal IN2 at the L level are supplied from the pre-driver 102 to the bridge control logic circuit 103.

The bridge control logic circuit 103 turns on the switching element SW1 and the switching element SW4 in accordance with the supplied signal and turns off the switching element SW2 and the switching element SW3. The voltage level of OUT1 corresponding to one end of the motor coil MC (one end on the connection point side for the switching element SW1 and the switching element SW2) is set as H. The voltage level of OUT2 corresponding to the other end of the motor coil MC (one end on the connection point side for the switching element SW3 and the switching element SW4) is set as L.

When the control for setting the motor in the reverse rotation state is executed, the signal level of the signal IN1 is set as L, and the signal level of the signal IN2 is set as H. A time corresponding to the time width for setting the motor in the reverse rotation state, the signal IN1 at the L level, and the signal IN2 at the H level are supplied from the pre-driver 102 to the bridge control logic circuit 103.

The bridge control logic circuit 103 turns on the switching element SW2 and the switching element SW3 in accordance with the supplied signal and turns off the switching element SW1 and the switching element SW4. The voltage level of OUT1 corresponding to one end of the motor coil MC is set as L. The voltage level of OUT2 corresponding to the other end of the motor coil MC is set as H.

### Example of Pulse Width

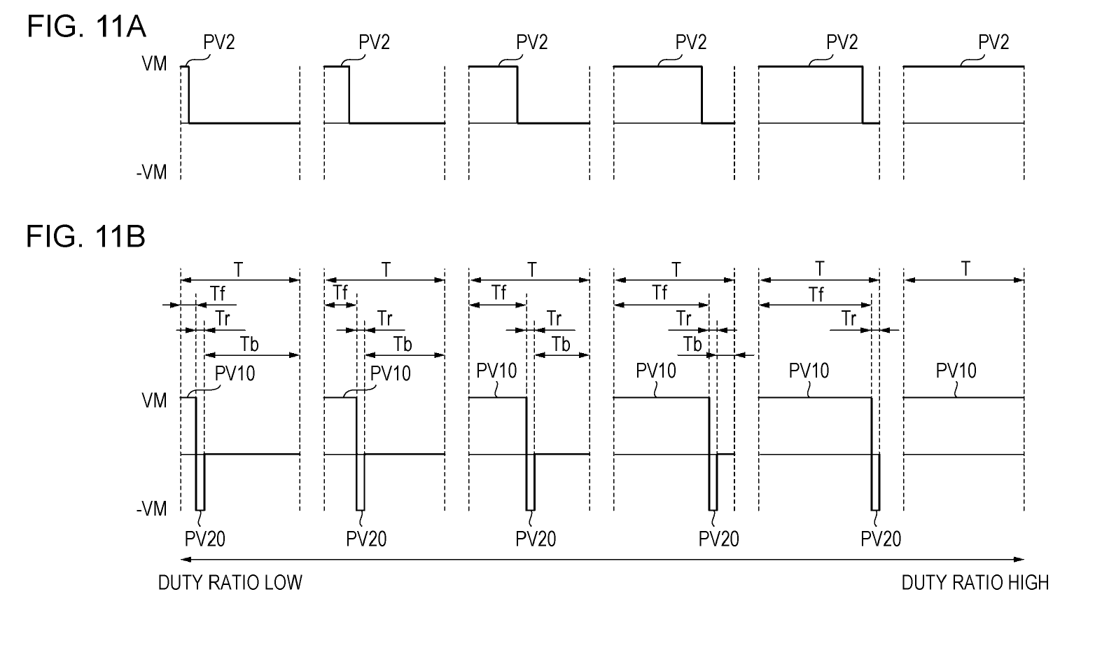

FIGS. 11A and 11B illustrate a pulse width of the pulse voltage in the intermittent drive PWM control system in contrast with a pulse width of the pulse voltage in the present control system. FIG. 11A illustrates a pulse width of the pulse voltage in the intermittent drive PWM control system, and FIG. 11B illustrates a pulse width of the pulse voltage in the present control system. The pulse voltage corresponding to the up and down directions while facing the drawing corresponds to a same duty ratio. The duty ratio is lower along the left side, and the duty ratio is higher along the right side while facing the drawing.

FIG. 11A schematically illustrates a pulse width of the pulse voltage applied in the intermittent drive PWM control system. In one cycle T, only a positive polarity pulse voltage is applied. The problems caused in the intermittent drive PWM control system have been described above, and a duplicated description will be omitted.

FIG. 11B schematically illustrates a pulse width of the pulse voltage applied in the present control system. In the one cycle T, a positive polarity pulse voltage PV10 and a negative polarity pulse voltage PV20 are applied. The pulse voltage PV10 is applied during the pulse width Tf which is set as a time width larger than or equal to the predetermined time width. The pulse voltage PV20 is applied during the pulse width Tr having a same time width as the predetermined time width. In this manner, in the present control system, the pulse voltages having the different polarities are applied in the one cycle.

At the duty ratio at 0%, the pulse widths of the pulse voltage PV10 and the pulse voltage PV20 are set as a same pulse width. Furthermore, in a case where the duty ratio is high (for example, 100%), the pulse width of the pulse voltage PV20 is set as 0, and this point will be described below.

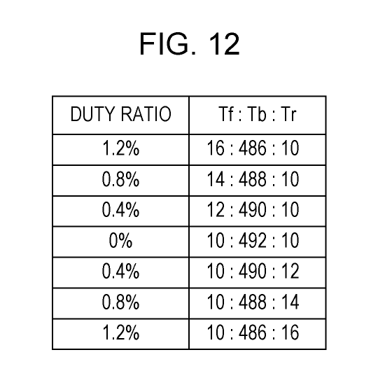

FIG. 12 illustrates examples of the pulse widths set at the duty ratio at 0% and in the vicinity of the duty ratio at 0% (for example, 0.4%, 0.8%, and 1.2%) (the pulse width Tf, the pulse width Tb, and the pulse width Tr). At least when the motor output is in the low output region, even in a case where the motor is controlled in one of the three states, the pulse width Tf and the pulse width Tr are set as the predetermined time width at 10 or higher. With this configuration, a period of the conductive state during which the motor rotates in the forward rotation direction and a period of the conductive state during which the motor rotates in the reverse rotation direction are set to be longer than or equal to a predetermined period.

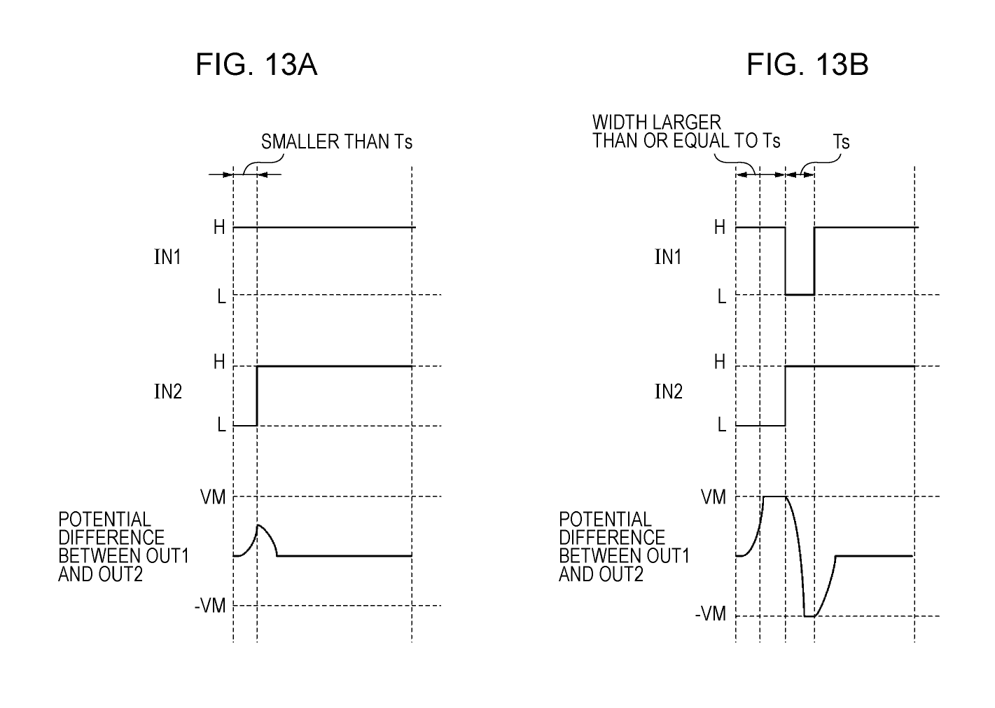

FIG. 13A schematically illustrates a result of a processing in the intermittent drive PWM control system. In a case where the duty ratio is low, the pulse which of the pulse voltage is smaller than a time in which the switching element rises. Since the switching element of the driver circuit is not turned on, the voltage between both the ends of the motor does not fully rise to the voltage VM. In contrast to this, in the present control system illustrated in FIG. 13B, the pulse widths for applying the pulse voltages having the different polarities are both set as a time width Ts or larger. For this reason, the switching element of the driver circuit is turned on, and the voltage between both the ends of the motor fully rises to the voltage VM.

As described above, according to the present control system, while the low power consumption is realized, it is possible to avoid the decrease in the linearity of the motor output. In addition, it suffices if only the pulse voltages having the different polarities are applied in the one cycle, so that a new configuration is not added. Thus, the cost of the apparatus is not increased, and the size of the apparatus is not increased. Furthermore, since the one cycle in the control (the one modulation period) is not changed, the cycle is lengthened, and it is possible to avoid the generation of the noise from the motor.

It should be noted that according to the present disclosure, the predetermined time width is not defined by the ratio to the pulse modulation width (modulation period). For this reason, even when the pulse modulation width (modulation period) is changed, the pulse width where the pulse voltage PV10 is applied and the pulse width where the pulse voltage PV20 is applied can be set to be larger than or equal to the predetermined time width.

### Processing in High Output Region

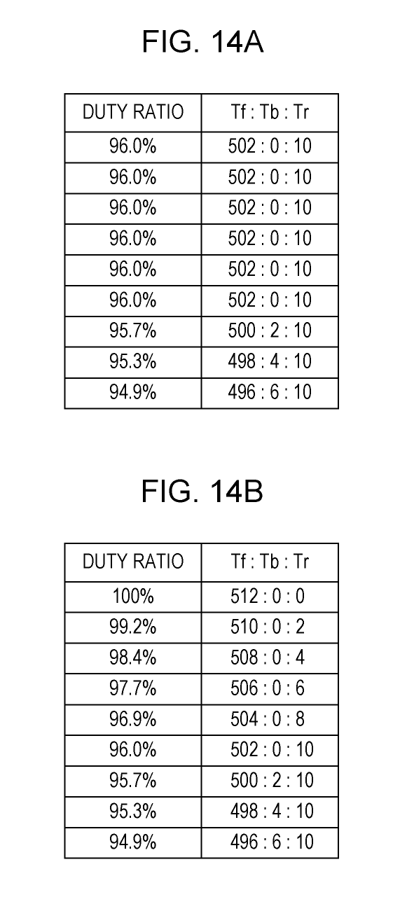

A processing in a case where the motor output is in the high output region will be described. In a case where the duty ratio at 100% may be not accurately realized when the mode is the forward rotation, as exemplified in FIG. 14A, the pulse width Tr may be set as the predetermined time width. For example, in a case where the duty ratio is 100%, the pulse width Tr is set as the time width at 10 that is the same as the predetermined time width, and the pulse width Tf is set as 502 calculated by subtracting 10 from 512. The pulse width Tb is set as 0.

In this case, on the basis of (502−10)/512, the duty ratio is approximately 96.0%. Although the duty ratio at 100% is not accurately realized, the processing in the low output region may not be different from the processing in the high output region. When the motor output is in the high output region, the states are switched in the one cycle so as to include the conductive state in which the motor rotates in the forward rotation direction and the conductive state in which the motor rotates in the reverse rotation direction. The ground state may not be set.

In a case where the duty ratio at 100% is accurately realized, as exemplified in FIG. 14B, as approaching the duty ratio at 100%, the pulse width Tf may gradually be increased, and the pulse width Tr may gradually be decreased. For example, the pulse width Tr is set as 512, and the pulse width Tb and the pulse width Tr is set as 0, so that the duty ratio at 100% can accurately be realized.

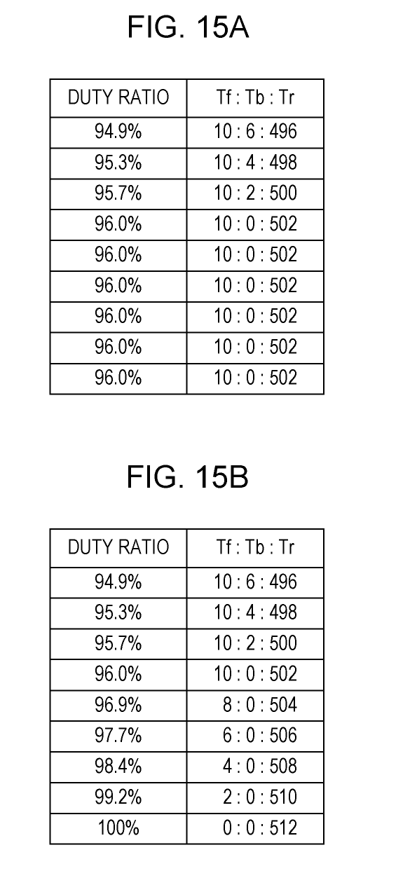

In a case where the duty ratio at 100% may be not accurately realized when the mode is the reverse rotation, for example, as exemplified in FIG. 15A, the pulse width Tf may be set as the time width that is same as the predetermined time width. For example, in a case where the duty ratio is 100%, the pulse width Tf set as the time width at 10 that is same as the predetermined time width, and the pulse width Tr is set as 502 calculated by subtracting 10 from 512. The pulse width Tb is set as 0.

In this case, on the basis of (502−10)/512, the duty ratio is approximately 96.0%. Although the duty ratio at 100% is not accurately executed, the processing in the low output region and the processing in the high output region may be not different from each other.

In a case where the duty ratio at 100% is accurately executed, as exemplified in FIG. 15A, as approaching the duty ratio at 100%, the pulse width Tf may gradually be decreased, and the pulse width Tr may gradually be increased. For example, the pulse width Tr is set as 512, and the pulse width Tb and the pulse width Tr is set as 0, so that the duty ratio at 100% can accurately be realized.

It should be noted that if a switching timing for the conductive state in which the motor rotates in the forward rotation direction and the conductive state in which the motor rotates in the reverse rotation direction is overlapped with a timing for an AD converter to acquire a signal different from the motor, electric noise may be generated. For example, in the case of a position sensor signal, noise may be generated. In addition, in the case of an image sensor signal, the video may be disturbed.

To solve this problem, in a region where the duty ratio is lower than 100%, the pulse width Tf may gradually be increased, and the pulse width Tr may gradually be decreased (in the case of the forward rotation).

Similarly, also in the case of the motor reverse rotation, in a region where the duty ratio is lower than 100%, the pulse width Tf is gradually decreased, and the pulse width Tr is gradually increased.

By setting this duty ratio as a value at which the timing does not collide with the acquisition timing for the AD converter and also the linearity characteristic of the motor output is not degraded, it is possible to ameliorate the degradation in the linearity characteristic of the motor output without an adverse effect on another signal.

### 2. MODIFIED EXAMPLES

The embodiment of the present disclosure has been described above, but the present disclosure is not limited to the above-mentioned embodiment, and various modifications can be made. Hereinafter, modified examples will be described.

The present disclosure can widely be applied to a driving apparatus in which the motor coil drives and controls a single DC motor in addition to various driving apparatuses configured to drive and control motors having other configurations. Numeric values such as the predetermined time width and the one cycle are merely examples and are not limited to the exemplified numeric values.

The present disclosure can be executed as an apparatus as well as a method. The configurations and processings according to the embodiment and modified examples can appropriately be deleted or changed so long as a technical incoherence is not caused.

The present disclosure can also adopt the following configurations.
(1) A driving apparatus configured to switch states in one modulation period so as to include a conductive state in a first drive direction, a conductive state in a second drive direction having a polarity different from the conductive state in the first drive direction, and a ground state at least when a motor output is in a low output region including a case where a duty ratio of a PWM control is at zero, in which the duty ratio is changed by changing periods of the respective states.
(2) The driving apparatus according to (1), in which the period of the conductive state in the first drive direction and the period of the conductive state in the second drive direction are set to be longer than or equal to a predetermined period.
(3) The driving apparatus according to (1) or (2), in which when the motor output is in a high output region that has a higher output than the low output region, the states are switched in the one modulation period so as to include the conductive state in the first drive direction and the conductive state in the second drive direction, and in which the duty ratio is changed by changing the periods of the respective states.
(4) The driving apparatus according to (1) or (2), in which when the motor output is in a high output region that has a higher output than the low output region, one of the periods of the conductive state in the first drive direction and the conductive state in the second drive direction is gradually increased, and the other period is gradually decreased.
(5) A driving method including: switching states in one modulation period so as to include a conductive state in a first drive direction, a conductive state in a second drive direction having a polarity different from the conductive state in the first drive direction, and a ground state at least when a motor output is in a low output region including a case where a duty ratio of a PWM control is at zero; and changing periods of the respective states to change the duty ratio.

The present disclosure contains subject matter related to that disclosed in Japanese Priority Patent Application JP 2012-043440 filed in the Japan Patent Office on Feb. 29, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A driving apparatus configured to switch states in one modulation period so as to include a conductive state in a first drive direction, a conductive state in a second drive direction having a polarity different from the conductive state in the first drive direction, and a ground state at least when a motor output is in a low output region including a case where a duty ratio of a PWM control is at zero,
wherein the duty ratio is changed by changing periods of the respective states.

2. The driving apparatus according to claim 1,
wherein the period of the conductive state in the first drive direction and the period of the conductive state in the second drive direction are set to be longer than or equal to a predetermined period.

3. The driving apparatus according to claim 1,
wherein when the motor output is in a high output region that has a higher output than the low output region,
the states are switched in the one modulation period so as to include the conductive state in the first drive direction and the conductive state in the second drive direction, and
wherein the duty ratio is changed by changing the periods of the respective states.

4. The driving apparatus according to claim 1,
wherein when the motor output is in a high output region that has a higher output than the low output region,
one of the periods of the conductive state in the first drive direction and the conductive state in the second drive direction is gradually increased, and the other period is gradually decreased.

5. A driving method comprising:
switching states in one modulation period so as to include a conductive state in a first drive direction, a conductive state in a second drive direction having a polarity different from the conductive state in the first drive direction, and a ground state at least when a motor output is in a low output region including a case where a duty ratio of a PWM control is at zero; and
changing periods of the respective states to change the duty ratio.
